(19) United States
(12) Patent Application Publication
(10) Pub. No.: US 2019/0300264 A1
(43) Pub. Date: Oct. 3, 2019

(54) Packaging Material With Absorption Features

(71) Applicant: Graphic Packaging International, LLC, Atlanta, GA (US)

(72) Inventor: Aaron Bates, Kennesaw, GA (US)

(21) Appl. No.: 16/361,713

(22) Filed: Mar. 22, 2019

Related U.S. Application Data
(60) Provisional application No. 62/648,633, filed on Mar. 27, 2018.

(51) Int. Cl. B65D 81/26; B32B 29/06; B32B 29/00; B32B 3/26; B32B 9/00

(52) U.S. Cl. CPC B65D 81/264; B32B 29/06; B32B 29/002; B32B 2315/16; B32B 9/005; B32B 2439/70; B32B 3/26

(57) ABSTRACT

A packaging material for forming a construct for holding a food product. The packaging material can comprise at least a base layer and a coating on a face of the base layer. Absorption features can extend in at least one of the coating and the base layer for allowing fluids to pass to an interior of the base layer.

### CROSS-REFERENCE TO RELATED APPLICATIONS

This application claims the benefit of U.S. Provisional Patent Application No. 62/648,633, filed on Mar. 27, 2018.

### INCORPORATION BY REFERENCE

The disclosures of U.S. Provisional Patent Application No. 62/648,633, filed Mar. 27, 2018, U.S. patent application Ser. No. 15/373,900, filed Dec. 9, 2016, and U.S. Provisional Patent Application No. 62/266,084, filed Dec. 11, 2015, are hereby incorporated by reference as if presented herein in their entirety and are incorporated by reference for all purposes.

### BACKGROUND OF THE DISCLOSURE

The present disclosure relates to packaging material for blanks, containers, trays, cartons, and other suitable constructs. More specifically, the disclosure is generally directed to a packaging material having features on a surface for allowing moisture to reach an absorbent internal layer.

### SUMMARY OF THE DISCLOSURE

In general, one aspect of the disclosure is generally directed to a packaging material for forming a construct for holding a food product. The packaging material can comprise at least a base layer and a coating on a face of the base layer. Absorption features can extend in at least one of the coating and the base layer for allowing fluids to pass to an interior of the base layer.

In another aspect, the disclosure is generally directed to a method of forming a packaging material for forming a construct for holding a food product. The method can comprise obtaining a material comprising at least a base layer and a coating on a face of the base layer and forming absorption features in at least one of the coating and the base layer for allowing to fluids pass to an interior of the base layer.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a schematic plan view of a surface of a packaging material with absorption features according to a first exemplary embodiment of the disclosure.

FIG. 1A is a schematic view of absorption features of FIG. 1 having absorbed moisture according to the first exemplary embodiment of the disclosure.

FIGS. 2A-2D are schematic partial cross-sectional views of the packaging material of FIG. 1 according to exemplary embodiments of the disclosure.

FIG. 3 is a schematic plan view of a surface of a packaging material with absorption features according to a second exemplary embodiment of the disclosure.

Corresponding parts are designated by corresponding reference numbers throughout the drawings.

### DETAILED DESCRIPTION OF THE EXEMPLARY EMBODIMENTS

The present disclosure relates generally to various aspects of a packaging material for containers, constructs, trays, materials, packages, elements, and articles, and methods of making such packaging material, containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to a packaging material for forming a container or tray for holding food items or various other articles. However, in other embodiments, the container or tray can be used to hold other non-food containing articles or may be used for heating or cooking and/or the packaging material could be used to form other suitable constructs.

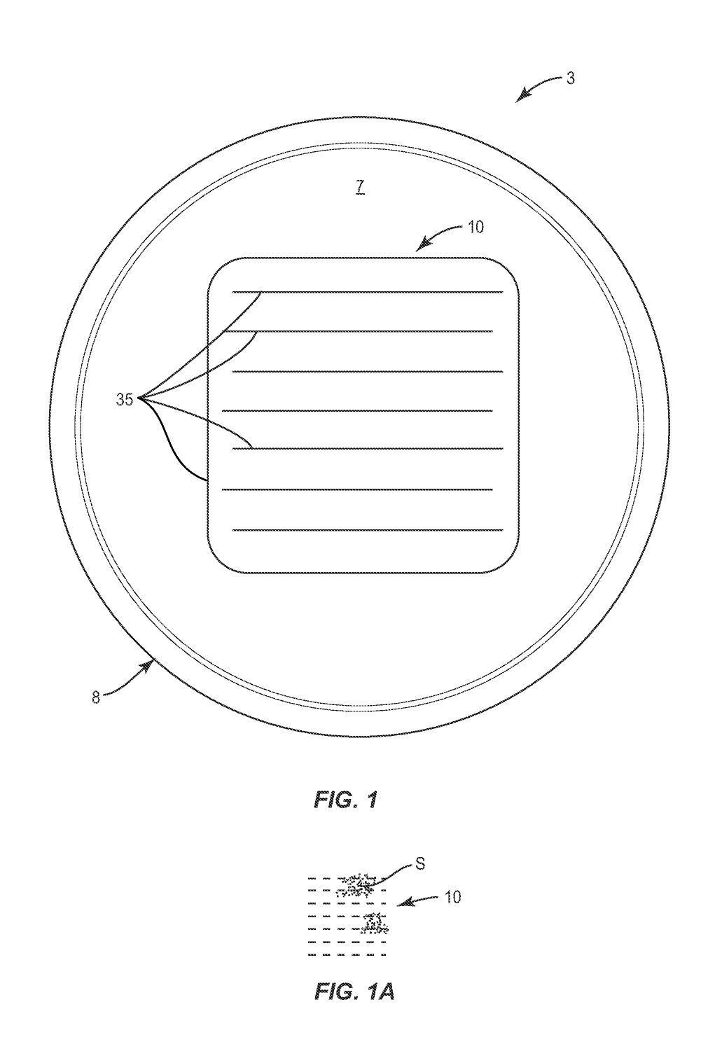

FIG. 1 illustrates a portion 3 (e.g., a blank) of a packaging material 8, wherein the portion 3 could be used to form a container or other construct (not shown) according to an exemplary embodiment of the disclosure. A surface 7 of the portion 3 is shown in FIG. 1. In the illustrated embodiment, the portion 3 can include absorption features 10 extending in the surface 7 of the packaging material 8. The portion 3 and/or the packaging materials could be alternatively shaped without departing from the scope of this disclosure.

As shown in FIG. 1, the absorption features 10 can include a plurality of partial cuts or slits 35 arranged in a series of lines surrounded by a rectangle with rounded corners. The absorption features could be arranged in any suitable pattern or configuration without departing from the disclosure. In addition, in alternative embodiments, the absorption features 10 could include perforations and/or partial perforations that extend at least partially through the packaging material 8. The perforations can be in the form of full and/or partial cuts, slits, pin points, apertures, openings, etc. In one embodiment, the absorption features 10 can be for at least partially absorbing moisture and/or moisture vapor into the interior of the packaging material 8, wherein the moisture is schematically shown generally at S in FIG. 1A.

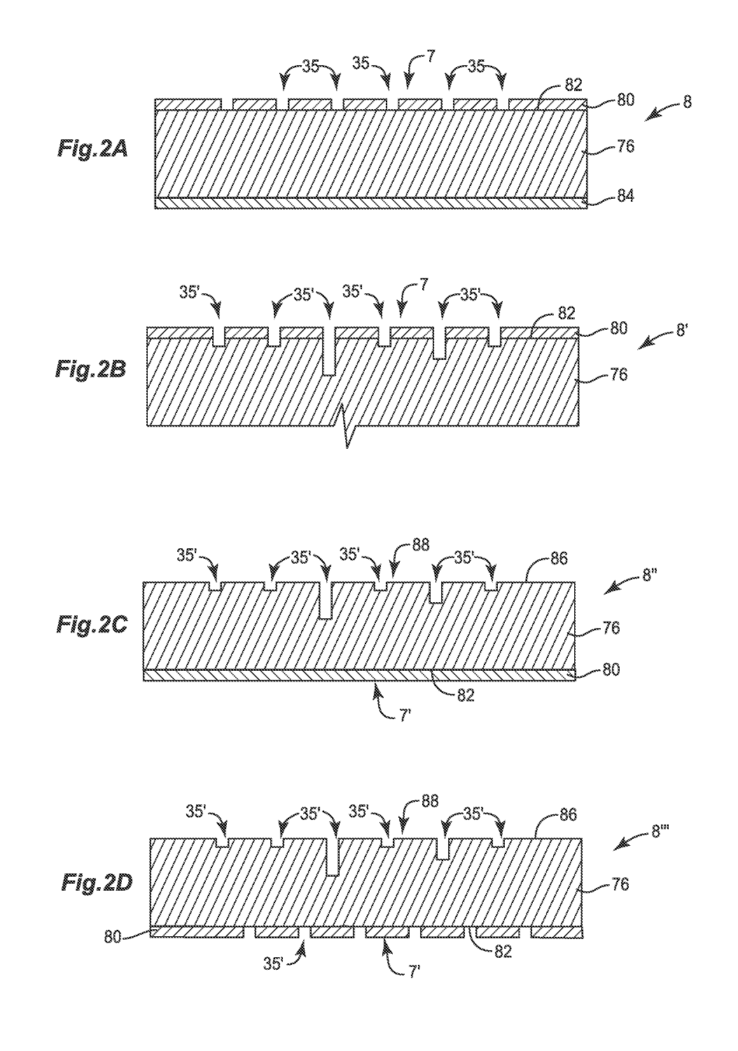

FIG. 2A shows a schematic cross-sectional view of the packaging material 8 according to an exemplary embodiment. The packaging material 8 can include a base layer 76 (e.g., paperboard) and a coating 80 on a face 82 of the base layer 76. In one embodiment, the coating 80 can be a clay coating, which can be commonly associated with paperboard packaging materials. Alternatively, the coating 80 could be any suitable barrier layer, film, coating, and/or laminated material without departing from the disclosure. In an exemplary embodiment, the coating 80 can at least partially form a barrier to moisture and/or moisture vapor so that moisture and/or moisture vapor is generally prevented from engaging the base layer 76. Accordingly, moisture can collect on the surface 7 of the packaging material 8 and/or moisture vapor can condense and collect on the surface 7, and such moisture can contribute to undesirable features (e.g., sogginess) of a food product or other article held by a container formed from the packaging material. However, the absorption features 10 (e.g., partial cuts 35) can be included in the surface 7 for allowing moisture and/or moisture vapor to engage the base layer 76 and be at least partially absorbed by the paperboard of the base layer 76. In one embodiment, an optional coating, film, laminated material, etc. 84 can be included on the face of the base layer 76 opposite to the face 82.

As shown in FIG. 2A, the partial cuts 35 can extend in the coating 80 to the face 82 of the base layer 7. In another embodiment shown in FIG. 2B, the alternative packaging material 8′ can have partial cuts 35′ that can extend through the face 82 into the base layer 76. As shown in FIG. 2B, the partial cuts 35′ can extend to various depths in the base layer 76. Alternatively, the partial cuts 35′ could extend to any suitable depth and/or can be formed at similar or identical depths. As shown in FIG. 2C, the packaging material 8″ can include partial cuts 35′ formed in an uncoated face 86 of the base layer 76 at a surface 88 of the packaging material 8″. In one embodiment, the coating 80 on the face 82 can be generally free of cuts and can form a surface 7′ of the packaging material 8″. As shown in FIG. 2D, the packaging material 8′″ can be similar to the packaging material 8″ of FIG. 2C with partial cuts 35 and/or partial cuts 35′ (not shown) in the coating 80 and/or the face 82 of the base layer 76. The packaging material could be otherwise shaped, arranged, configured, and/or positioned without departing from the disclosure. For example, the packaging material could include any suitable layers of paperboard and/or any suitable coatings.

In the illustrated embodiment, the partial cuts 35, 35′ can provide passageways from the surface 7 and/or the surface 88 to the paperboard layer 76 for the transmission of moisture and/or moisture vapor to the paperboard layer. The partial cuts 35, 35′ can be formed by conventional cutting tools, and/or the perforations could be formed by applying the coating 80 as a patterned layer during a coating process (not shown). The patterned layer could include selective areas that are free from the coating 80 to allow moisture to be absorbed by the paperboard layer 76. The partial cuts 35, 35′ could be otherwise shaped, arranged, configured, and/or positioned without departing from the disclosure. For example, perforations of the absorption features 10 could be alternatively shaped (e.g., curved cuts, circular or polygonal apertures or punctures, and/or other suitable shapes) or could be otherwise positioned without departing from the disclosure.

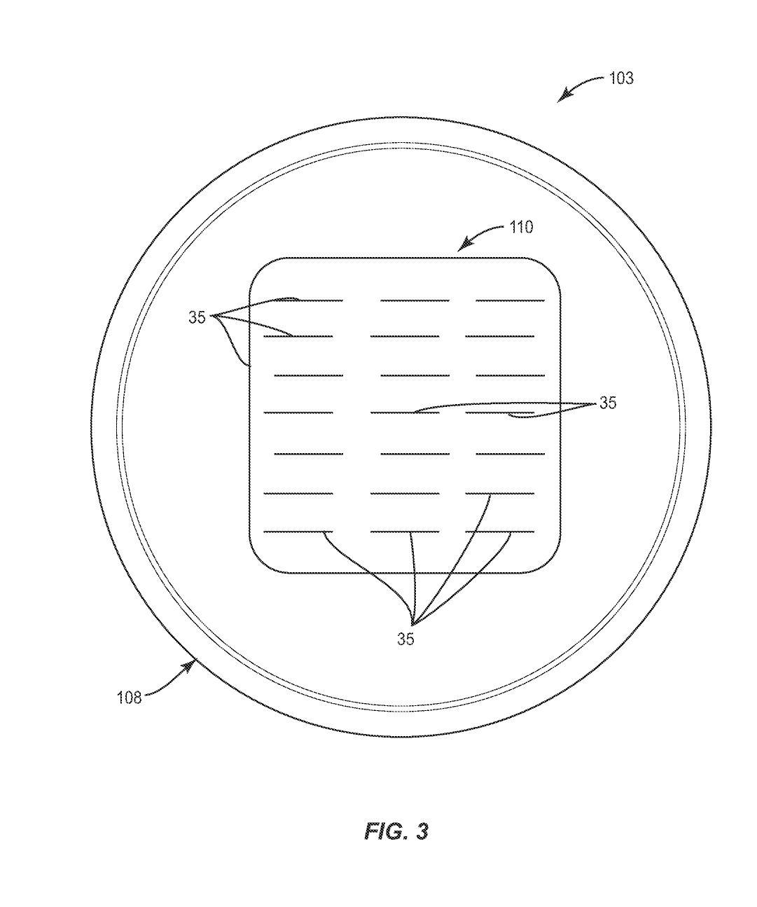

FIG. 3 is a plan view of a portion 103 of a packaging material 108 for forming a container (not shown) according to a second embodiment of the disclosure. The second embodiment is generally similar to the first embodiment, except for variations noted and variations that will be apparent to one of ordinary skill in the art. Accordingly, similar or identical features of the embodiments have been given like or similar reference numbers. As shown in FIG. 3, the portion 103 can include an alternative absorption feature 110 with perforations (e.g., partial cuts 35) arranged in a spaced array. For example, as shown in FIG. 3, the perforations can be in the form of slits arranged in a plurality of spaced rows and spaced columns. Any of the perforations, lines, arrays, and/or other aspects of the absorption feature 110 could be omitted or could be otherwise shaped, arranged, configured, and/or positioned without departing from the disclosure.

In one embodiment, the absorption features 10, 110 can allow the paperboard of the base layer 76 to absorb moisture in order to keep the food or other items held in a container formed from the packaging materials 8, 8′, 8″, 8′″, 108 fresh and crunchy versus soft and mushy, which can be caused by moisture collecting on a surface of the packaging material and engaging the food product (e.g., being absorbed by the food product) if the absorption features are omitted. The disclosure also includes a method of altering one or more surfaces of a packaging material (e.g., to form perforations) in order to allow moisture vapor to reach the interior of the paperboard (e.g., the fibers of the paperboard). Accordingly, by strategically utilizing cuts, partial cuts, pin points, and/or other features, one can control the amount of linear inches of the paperboard exposed, which would allow moisture vapors to enter and be absorbed by the fibers of the paperboard. In one exemplary embodiment, the configuration of the absorption features 10 in FIG. 1 had a 13 percent increase in moisture absorption relative to a control sample with no absorption features in a test. In another exemplary example, the configuration of the absorption features 110 in FIG. 3 had a 3 percent increase in moisture absorption relative to a control sample with no absorption features in another test. Accordingly, one can control the amount of moisture that can be absorbed by the base layer 76 via the absorption features 10, 110 by controlling the linear inches of the absorption features 10, 110 in the packaging material. For example, the total linear inches of the partial cuts 35 in FIG. 1 is greater than the total linear inches of the partial cuts 35 in FIG. 3, and the absorption features 10 allowed the packaging material 8 of FIG. 1 to absorb more moisture than did the absorption features 110 in the packaging material 108 of FIG. 3 in the exemplary embodiments noted above. The packaging material 8, 8′, 8″, 8′″, 108 could be otherwise configured and/or formed without departing from the disclosure.

Any of the features of the various embodiments of the disclosure can be combined with, replaced by, or otherwise configured with other features of other embodiments of the disclosure without departing from the scope of this disclosure.

Optionally, one or more portions of the blank or other constructs described herein or contemplated hereby may be coated with varnish, clay, or other materials, either alone or in combination. The coating may then be printed over with product advertising or other information or images. The blanks or other constructs also may be selectively coated and/or printed so that less than the entire surface area of the blank or substantially the entire surface area of the blank may be coated and/or printed.

All dimensional information presented herein is intended to be illustrative of certain aspects, features, etc., of various embodiments of the disclosure, and is not intended to limit the scope of the disclosure. The dimensions of the blanks, containers, forming tools, features, or any other dimension, can be more or less than what is shown and described in this disclosure without departing from the scope of this disclosure and can be within the listed ranges of dimensions for each feature or outside the listed ranges of dimensions for each feature without departing from the scope of this disclosure.

In accordance with the exemplary embodiments, the blanks may be constructed of paperboard of a caliper such that it is heavier and more rigid than ordinary paper. The blanks can also be constructed of other materials, such as cardboard, hard paper, or any other material having properties suitable for enabling the carton package to function at least generally as described above.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A packaging material for forming a construct for holding a food product, the packaging material comprising:
at least a base layer and a coating on a face of the base layer; and
absorption features extending in at least one of the coating and the base layer for allowing to fluids pass to an interior of the base layer.

2. The packaging material of claim 1, wherein the absorption features comprise a plurality of passageways extending at least partially through at least one of the base layer and the coating.

3. The packaging material of claim 2, wherein the coating extends along a face of the base layer and the passageways extend through the coating to the face of the base layer.

4. The packing material of claim 2, wherein the passageways extend through the coating and into the base layer.

5. The packaging material of claim 2, wherein the passageways comprise perforations extending at least partially through at least one of the base layer and the coating.

6. The packaging material of claim 2, wherein the passageways comprise slits extending at least partially through at least one of the base layer and the coating.

7. The packaging material of claim 2, wherein the passageways are arranged in an array on at least a portion of the packaging material.

8. The packaging material of claim 1, wherein the base layer comprises paperboard and the coating is a clay coating on the paperboard.

9. The packaging material of claim 8, wherein the absorption features comprise a plurality of passageways extending through the clay coating.

10. The packaging material of claim 8, wherein the absorption features comprise a plurality of passageways extending in at least the paperboard.

11. The packaging material of claim 1, wherein the face of the base layer is a first face, the base layer comprises a second face opposite to the first face, and the packaging material comprises a film on the second face of the base layer.

12. The packaging material of claim 11, wherein the base layer comprises paperboard and the coating is a clay coating on the paperboard, and the absorption features comprise a plurality of passageways extending through the clay coating and into the base layer.

13. The packaging material of claim 1, wherein the face of the base layer is a first face, the base layer comprises a second face opposite to the first face and extending along an outer surface of the packaging material, and the absorption features extend in the second face of the base layer.

14. A method of forming a packaging material for forming a construct for holding a food product, the method comprising:
obtaining a material comprising at least a base layer and a coating on a face of the base layer; and
forming absorption features in at least one of the coating and the base layer for allowing to fluids pass to an interior of the base layer.

15. The method of claim 14, wherein the forming the absorption features comprises controlling an amount of linear inches of the absorption features in the at least one of the coating and the base layer to control a potential amount of fluids absorbed by the base layer via the absorption features.

16. The method of claim 14, wherein the forming the absorption features comprises forming a plurality of passageways extending at least partially through at least one of the base layer and the coating.

17. The method of claim 16, wherein the coating extends along a face of the base layer and the forming the plurality of passageways comprises cutting through the coating to the face of the base layer.

18. The method of claim 16, wherein the forming the plurality of passageways comprises cutting through the coating and into the base layer.

19. The method of claim 16, wherein the forming the plurality of passageways comprises arranging the passageways in an array on at least a portion of the packaging material.

20. The method of claim 14, wherein the base layer comprises paperboard and the coating is a clay coating on the paperboard.

21. The method of claim 20, wherein the forming the absorption features comprises forming a plurality of passageways that extend through the clay coating.

22. The method of claim 20, wherein the forming the absorption features comprises forming a plurality of passageways that extend in at least the paperboard.

23. The method of claim 14, wherein the face of the base layer is a first face, the base layer comprises a second face opposite to the first face, and the packaging material comprises a film on the second face of the base layer.

24. The method of claim 14, wherein the face of the base layer is a first face, the base layer comprises a second face opposite to the first face and extending along an outer surface of the packaging material, and the forming the absorption features comprises forming the absorption features in the second face of the base layer.
